(19) United States
(12) Patent Application Publication
(10) Pub. No.: US 2008/0143079 A1
(43) Pub. Date: Jun. 19, 2008

(54) Trailer Step Assembly

(76) Inventor: Lawrence Abel LeBouef, Arlington, TN (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 11/951,900

(22) Filed: Dec. 6, 2007

Related U.S. Application Data
(62) Division of application No. 10/775,293, filed on Feb. 10, 2004, now abandoned.
Application No. 10/775,293 is a continuation of application No. 11/352,872, filed on Feb. 13, 2006.

(51) Int. Cl. B60D 1/36

(52) U.S. Cl. 280/477

(57) ABSTRACT

This invention relates to trailer assistance apparatus and method of use of the apparatus. More specifically, a trailer docking assistance device is disclosed having an inflexible, fixed marker member permanently secured to a magnetic mounting member sized to reversibly attach the marker member to a towing vehicle. Additionally, this invention relates to a trailer hitch step assembly comprising trailer hitch comprising mounting plate adapted to be received and secured to a bumper, a base member having a top and bottom surface, and two sided surface attached to said mounting plate and forming a base for a hitch ball wherein said hitch ball is substantially lower than said bumper; and a plate fixedly attached to said bottom surface of said base member having a plurality of flanges projecting substantially perpendicularly to said side surface of said base member to form a plurality of foot steps. This invention also provides a method to use these trailer assistance apparatuses.

### RELATED APPLICATIONS

This application is a divisional of application Ser. No. 10/775,293, and is a continuation of co-pending application Ser. No. 11/352,872.

### FIELD OF THE INVENTION

This invention relates to apparatuses that facilitate the use of a trailer and the method that uses these apparatuses. More specifically, a trailer docking apparatus and a trailer hitch step assembly are disclosed.

### BACKGROUND OF THE INVENTION

Properly aligning a trailer hitch ball receiver with a vehicle's hitch ball is often difficult and requires a great deal of time, as well as trial and error. Additionally, in order to view the progress of aligning a trailer hitch ball receiver with a vehicle's hitch ball, the driver must enter the truck bed repeatedly. To facilitate this coupling, various devices have been designed. Jarosek, et al., U.S. Pat. No. 0051654A1 shows a device with a vertical telescope rod assembly and horizontal telescope rod assembly with a semi-circular crook. Such trailer docking assembly requires maintenance and continuous adjustment. What is needed in this art is an assembly with no maintenance and little adjustment to facilitate the coupling of a trailer to a truck.

### SUMMARY OF THE INVENTION

The present invention includes a trailer docking assistance device made of an inflexible, fixed marker member permanently secured to a magnetic mounting member sized to reversibly attach said marker member to a mounting member attached to a vehicle or to the bottom of a bed of a vehicle or trailer.

The invention provides a method to facilitate docking a trailer to a vehicle by placing an inflexible, fixed marker member permanently secured to a magnetic mounting member substantially adjacent to a hitch ball on the trailer and viewing the marker member from the vehicle as the vehicle is docked with the trailer.

The invention further provides a method to facilitate maneuvering a trailer coupled to a vehicle by placing an inflexible, fixed marker member permanently secured to a magnetic mounting member to a metal portion of a trailer and viewing the marker member from the vehicle while maneuvering the vehicle.

The invention further includes a trailer hitch step assembly. The trailer hitch is made of a mounting plate adapted to be received and secured to a bumper, a base member having a top and bottom surface, and two sided surface attached to the mounting plate and forming a base for a hitch ball wherein the hitch ball is lower than the bumper. It also includes a plate fixedly attached to the bottom surface of the base member having a plurality of flanges projecting substantially perpendicularly to the side surface of the base member to form a plurality of foot steps.

The invention further includes a trailer assistance system to facilitate the use of a vehicle attached to a trailer made of a trailer hitch and a fixed marker member. The trailer hitch is made of a mounting plate adapted to be received and secured to a bumper, a base member having a top and bottom surface, and two sided surface attached to the mounting plate and forming a base for a hitch ball wherein the hitch ball is substantially lower than the bumper and a plate fixedly attached to the bottom surface of the base member having a plurality of flanges projecting substantially perpendicularly to the side surface of the base member to form a plurality of foot steps. The fixed marker member is inflexible and is permanently secured to a magnetic mounting member sized to reversibly attach to a magnetic portion of the trailer positioned to facilitate maneuvering of the vehicle.

### BRIEF DESCRIPTION OF THE DRAWINGS

FIG. 1 shows a schematic view of a towing vehicle with a trailer docking assistance device.

FIG. 2 shows a schematic view of a trailer docking assistance device.

FIG. 3 shows a schematic view of another embodiment of the trailer docking assistance device.

FIG. 4 shows a schematic top view of a step plate.

FIG. 5 shows a schematic top view of a step plate added to a ball hitch.

FIG. 6 shows a schematic side view of a step plate added to a ball hitch.

FIG. 7 shows a schematic bottom view of a step plate added to a ball hitch.

FIG. 8 shows a schematic view of a towing vehicle coupled to a trailer hitch step assembly and the trailer docking assistance device used to facilitate the coupling of a towing vehicle to a small trailer.

FIG. 9 shows a schematic view of a towing vehicle coupled to a trailer hitch step assembly and the trailer docking assistance device used to facilitate the coupling of a towing vehicle to a log splitter trailer.

### DETAILED DESCRIPTION OF THE PREFERRED EMBODIMENT

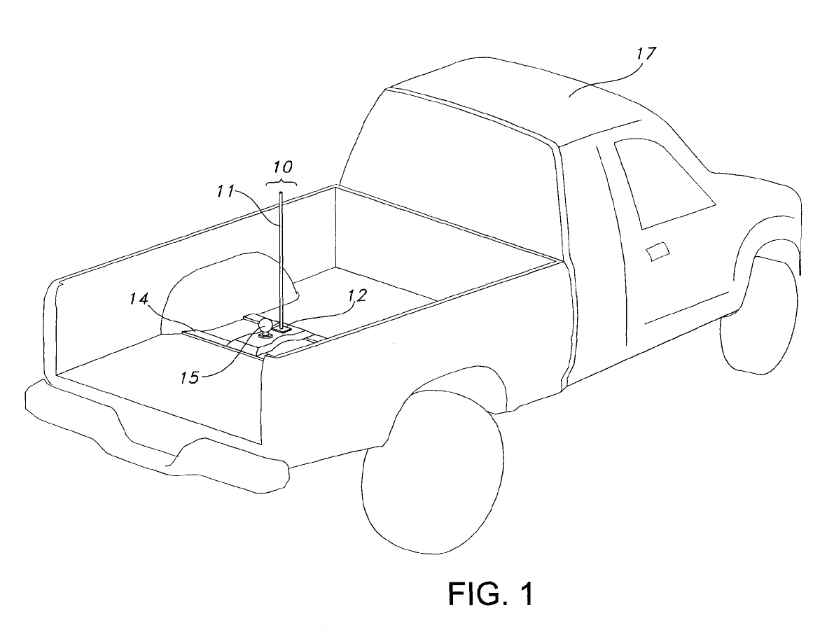

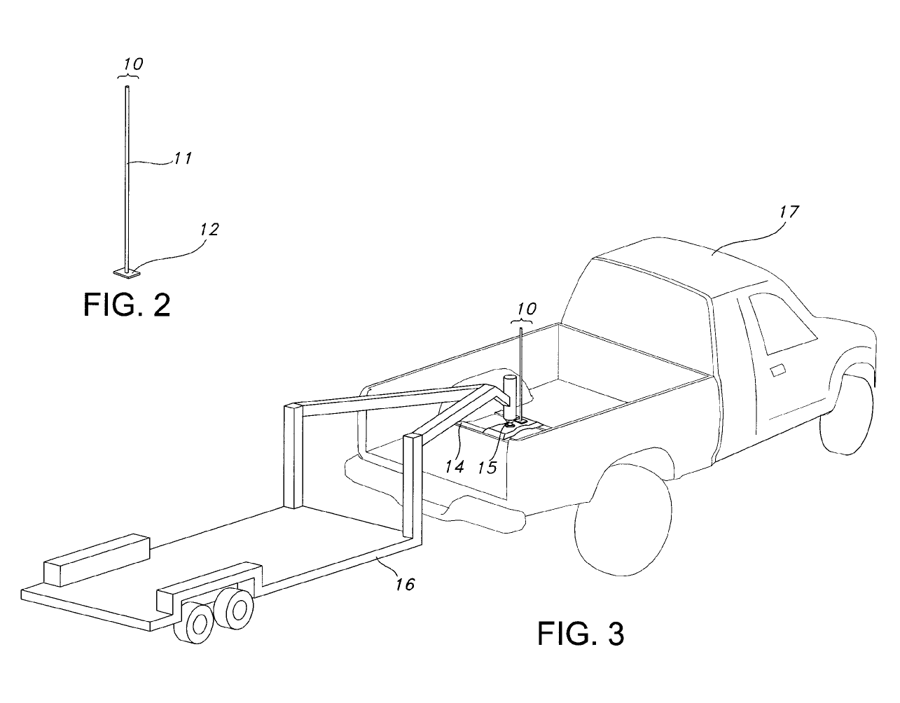

Referring to FIGS. 1 through 3, the trailer docking assistance device of tile present invention is identified by the reference number 10. Device 10 includes a magnetic mounting member 12. The magnetic mounting member 12 provides a means by which device 10 can be securely, but reversibly, attached to a towing vehicle 17, such as a pick-up truck having a gooseneck mounting member 14 attached thereto. The base of the magnetic mounting member 12 is sized to rest on a gooseneck trailer mounting member 14, or in the alternative embodiment, on the metal portion of the bed of the towing vehicle (not shown). The trailer docking assistance device 10 is positioned adjacent to the hitch ball 15. The trailer docking assistance device 10 is preferably within one inch of the hitch ball 15, but may be located at any distance from hitch ball 15 as desired by the end user as long as device 10 is placed so as to facilitate the docking of the trailer 16.

The trailer docking assistance device 10 is made of marker member 11 and a magnetic mounting member 12. The marker member 11 is made of an inflexible material, such as fiberglass, and is nonextensible (e.g., fixed). In the preferred embodiment, the marker member 11 is made of 3/16 inch fiberglass and is 36 inches in height, but can be cut by an end user to any desired height. The marker member 11 is nonextensible (e.g., fixed length) and thus does not require maintenance or continuous adjustment.

Referring in combination to FIG. 3, the preferred embodiment of the application of this device 10 is with a gooseneck trailer 16. The driver of the towing vehicle 17 reverses the towing vehicle 17 toward and in line with the gooseneck trailer 16 by reference to the trailer docking device 10 reversibly attached to the mounting member 12. When trailer 16 bumps device 10, the trailer 16 is positioned perfectly above the hitch ball 15.

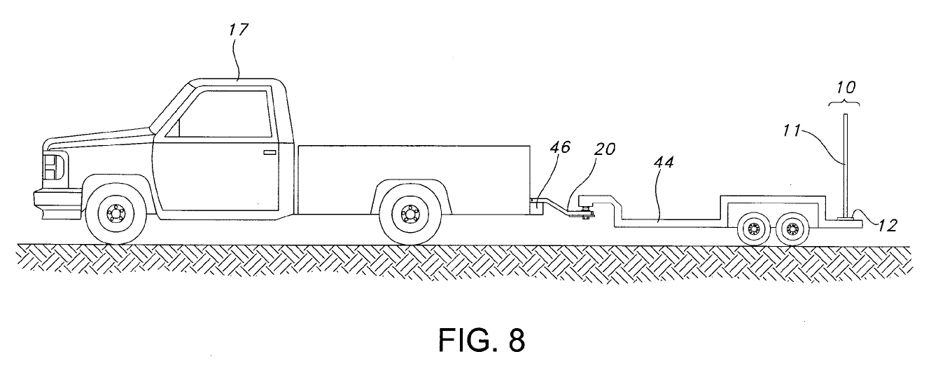

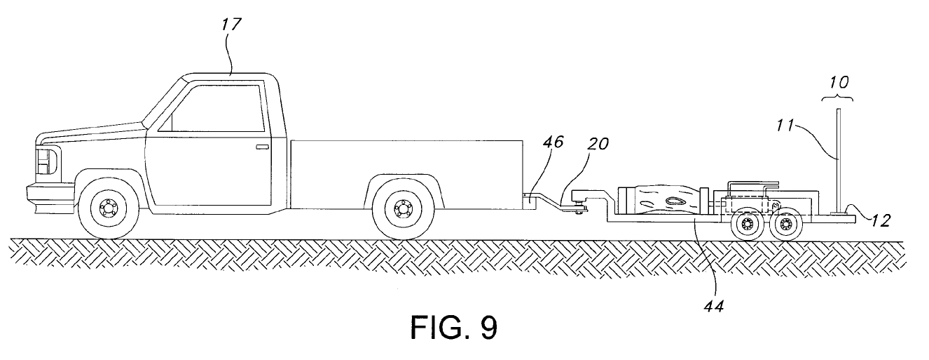

Referring now to FIGS. 8 and 9, the device 10 can be positioned on a metal portion of a trailer 44 to facilitate maneuvering of the trailer 44. The device 10 allows the driver to visually locate the rear of the trailer 44. Additionally, the device 10 can be positioned anywhere where there is a metal portion that requires assistance in maneuvering. The trailer 44 in this application is preferably a smaller trailer, such as a snow mobile trailer, a log splitter trailer (as shown in FIG. 9), or a jet ski trailer However, the device 10 can be positioned on any size trailer by the end user to allow end user to locate the rear of the trailer.

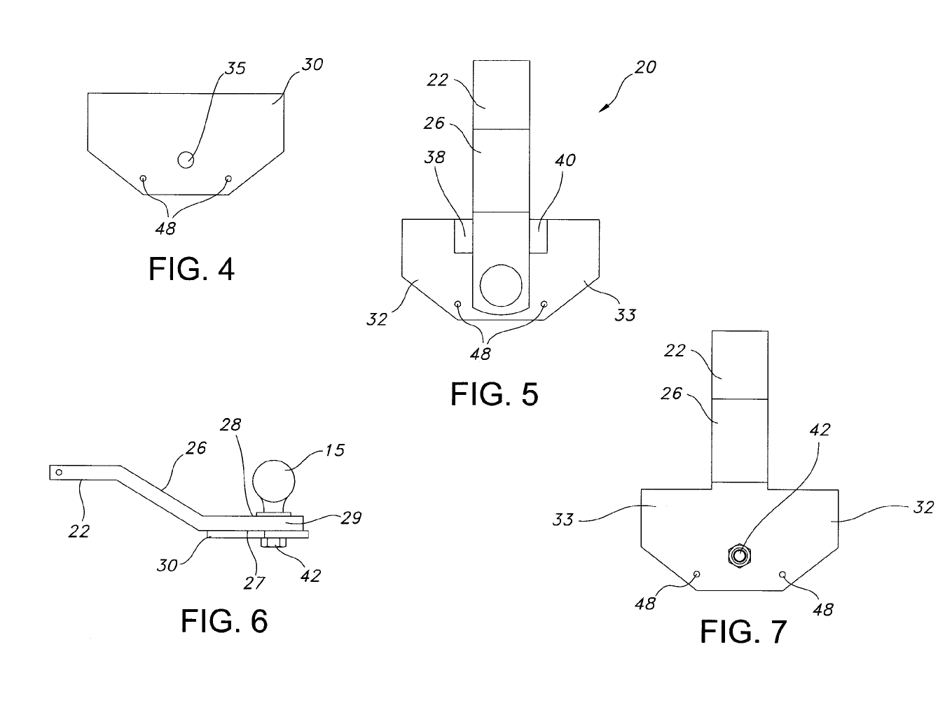

Referring now to FIGS. 4 through 7, views of a trailer hitch step assembly 20, a trailer hitch is shown having a mounting plate 22 adapted to be received and secured to a bumper (not shown), and a base member 26 having a top 28 and bottom 27 surface and a two side surface 29. The base member 26 attached to the mounting plate 22 provides a base for the hitch ball 15. A plate 30 is fixedly attached to the bottom surface 27 of the base member 26. The plate 30 has a plurality of flanges 32 and 33, which are substantially perpendicular to the side surface 29 of the base member 26 and form a plurality of foot steps. The plate 30 has a plurality of holes 48 configured to receive safety chains (not shown). In the preferred embodiment, the base member 26 contains an angle so that the hitch ball 15 is lower than the bumper (not shown) by two, four, or six inches. This difference in height is shown by the angle in base member 26. The plate 30 is attached to the base member 26 by at least one hole 35 through the plate 30 (shown in FIG. 4), base member 26 and hitch ball 15, through which at least one bolt 42 is attached. In the preferred embodiment, a plurality of retaining strips 38 and 40 are applied to the top surface 28 of the base member 26 to balance the positioning of hitch ball 15. The trailer hitch step assembly 20, including mounting plate 22, base member 26 and plate 30, is made of stainless steel, although other materials may be used as long as such materials are strong enough to allow the invention to be used as desired.

In an alternative embodiment, for additional security, another bolt (not shown) can be welded to the base member 26 and plate 30.

With reference to FIGS. 8 and 9, a side view of a towing vehicle 17 is shown coupled to a trailer 44, FIGS. 8 and 9 depicts a trailer assistance system to facilitate the use of a towing vehicle 17 attached to a trailer 44. Trailer 44 is coupled to the towing vehicle 17 by placing an inflexible, fixed marker member 11 permanently secured to a magnetic mounting member 12 substantially on the rear of said trailer 44 and by viewing the marker member 11 as the towing vehicle 17 is docked with the trailer 44. Fixed marker member 11 can be viewed by the operator of vehicle 17 allowing the operator of vehicle 17 to easily and accurately maneuver trailer 44. In another method of use of the device 10, the device 10 can be placed on the magnetic portion of a trailer 44 to facilitate viewing this portion of the trailer while maneuvering the towing vehicle 17 coupled to a trailer 44. Trailer hitch assembly 20 is secured to bumper 46 of towing vehicle 17 and to trailer 44.

Although the present invention has been described and illustrated with respect to preferred embodiments and a preferred use thereof, it is not to be so limited since modifications and changes can be made therein which are within the full scope of the invention.

I claim:

1. A trailer hitch step assembly comprising:
(a) trailer hitch comprising mounting plate adapted to be received and secured to a bumper, a base member having a top and bottom surface, and two sided surface attached to said mounting plate and forming a base for a hitch ball wherein said hitch ball is lower than said bumper; and
(b) a plate fixedly attached to said bottom surface of said base member having a plurality of flanges projecting substantially perpendicularly to said side surface of said base member to form a plurality of foot steps.

2. The assembly of claim 1 wherein said plate is fixedly attached to said base plate by a bolt in a hole within said base plate and hitch ball.

3. The assembly of claim 1 wherein said plate includes a plurality of holes configured to receive safety chains.
